(19) United States
(12) Patent Application Publication
(10) Pub. No.: US 2004/0056534 A1
(43) Pub. Date: Mar. 25, 2004

(54) Planar DC-DC converter for multi-volt electrical applications

(75) Inventors: Mario Linke, Kempen (DE); Marc Bleukx, Mechelen (BE)

Correspondence Address: OSTROLENK FABER GERB & SOFFEN, 1180 AVENUE OF THE AMERICAS, NEW YORK, NY, 100368403

(73) Assignee: International Rectifier Corp.

(21) Appl. No.: 10/454,260

(22) Filed: Jun. 3, 2003

Related U.S. Application Data
(60) Provisional application No. 60/385,966, filed on Jun. 3, 2002.

(51) Int. Cl. H02J 1/00

(52) U.S. Cl. 307/75

(57) ABSTRACT

An electrical arrangement provides power to a plurality of electrical systems, the electrical arrangement including a plurality of voltage buses; a plurality of voltage sources configured to supply respective electrical voltage potentials, the voltage sources being respectively assigned to the voltage buses, the voltage sources supplying the respective electrical voltage potentials to the respective voltage buses; at least one electrical system assigned to and electrically coupled to each of the voltage buses to receive electrical power; and a DC-DC converter arrangement electrically coupled to the voltage buses, the DC-DC converter being configured to convert at least one of the respective voltage potentials to another one of the respective voltage potentials, the DC-DC converter being mechanically and proximally coupled to at least one of the voltage sources.

### RELATED APPLICATIONS

The present application is based on and claims the benefit of U.S. Provisional Application Serial No. 60/385,966 filed on Jun. 3, 2002, entitled PLANAR CONSTRUCTION OF A DC-DC CONVERTER FOR AUTOMOTIVE APPLICATIONS, the entire contents of which are expressly incorporated herein by reference.

### BACKGROUND INFORMATION

Many of today's automobiles operate on fourteen-volt electrical systems, in which a fourteen-volt alternator is employed to charge a twelve-volt battery. However, as automobiles become increasingly more “high-tech” and hungry for electricity, the need for increased onboard electrical power in automobiles is growing rapidly.

To respond to the increased demand for electrical power, the automobile industry will soon be introducing cars that operate on fortytwo-volt power systems (fortytwo volts being provided by the alternator to charge thirtysix volt batteries), instead of the conventional fourteen-volt systems of today's cars. These fortytwo-volt systems will be able to deliver the necessary current to operate many of the “high-tech” computer and electrical systems expected in tomorrow's automobiles.

However, the change from fourteen-volt systems to fortytwo-volt systems will not be made overnight. Rather, the first fortytwo-volt systems will likely appear in hybrid automobiles capable of operating both fourteen-volt and fortytwo-volt automobile systems and, as such, will likely be provided with both twelve-volt and thirtysix-volt batteries (14-volt and 42-volt systems refer to the charge provided by the alternator of an automobile to charge 12-volt and 36-volt batteries, respectively). In some situations (e.g., if one of the batteries fails), the fourteen-volt battery may be required to provide electrical power to fortytwo-volt systems and/or the fortytwo-volt battery may be required to provide electrical power to fourteen-volt systems. For this purpose, the “hybrid” systems will require DC-DC converters capable of converting voltage from fourteen volts into fortytwo volts, and vice versa.

Referring now to FIG. 1, there is seen a hybrid electrical arrangement 100 according to the prior art. As shown in FIG. 1, electrical arrangement 100 includes a fourteen-volt battery 105 electrically coupled to at least one fourteen-volt electrical system 110 via a fourteen-volt bus 115, a fortytwo-volt battery 120 electrically coupled to at least one fortytwo-volt electrical system 125 via a fortytwo-volt bus 130, and a bi-directional DC-DC converter 135 electrically coupled to both fourteen-volt bus 115 and fortytwo-volt bus 130.

Fourteen-volt electrical system 110 and fortytwo-volt electrical system 125 may include any device configured to be operated, at least in part, by an electrical potential supplied by batteries 105, 130, respectively. For example, with respect to automobile applications, systems 110, 125 may include automobile computers, seat positioning motors, windshield wipers, headlights, steering wheel heaters, radios, etc.

In normal operation, fourteen-volt and fortytwo-volt batteries 105, 120 provide fourteen-volt and fortytwo-volt potentials to their respective busses 115, 130 to power electrical systems 110, 125. However, in at least some operating modes, it may be desirous to have fourteen-volt battery 105 provide power to fortytwo-volt electrical system 125 and/or to have fortytwo-volt battery 120 provide power to fourteen-volt system 110, for example, if one of batteries 105, 120 becomes inoperable. For this purpose, bi-directional DC-DC converter 135 includes an up-converter 140 configured to convert the fourteen-volt electrical potential produced by fourteen-volt battery 105 to the electrical potential of fortytwo-volt bus 130, and a down-converter 145 configured to convert the fortytwo-volt electrical potential produced by fortytwo-volt battery 120 to the electrical potential of fourteen-volt bus 115. For this purpose, for example, DC-DC converter 135 may be provided with a control input (not shown). In this manner, bi-directional DC-DC converter 135 may be controllably configured (e.g., by an automobile computer) to permit fourteen-volt battery 105 to operate fortytwo-volt electrical system 125 and/or fortytwo-volt battery 120 to operate fourteen-volt electrical system 110.

Although the conventional electrical arrangement 100 performs adequately for its intended purpose, it is believed that such a system is cumbersome and consumes much physical space. Furthermore, in various applications, such as automobile applications, operation of DC-DC converter 135 may generate unwanted heat energy, which may destroy or otherwise damage nearby sensitive components.

### SUMMARY OF THE INVENTION

It is an object of the present invention to overcome the disadvantages of prior art electrical systems described above. For this purpose, the present invention provides an electrical arrangement to supply power to a plurality of electrical systems, in which the DC-DC converter is designed in a planar fashion and mechanically and proximally coupled to at least one of the voltage sources. In this manner, the present invention provides for a compact and space-saving electrical system design.

It is another object of the present invention to provide the electrical system described above, in which the DC-DC converter is mechanically and heat-conductively coupled to a mounting arrangement. By arranging the DC-DC converter is such a manner, the mounting arrangement may dissipate excess heat generated by the DC-DC converter, thereby protecting nearby sensitive components from excess heat.

It is still another object of the present invention to provide the electrical system described above for use in a hybrid automobile system employing fourteen and fortytwo volt electrical systems.

### BRIEF DESCRIPTION OF THE DRAWINGS

FIG. 1 is a block diagram of an electrical power system according to the prior art.

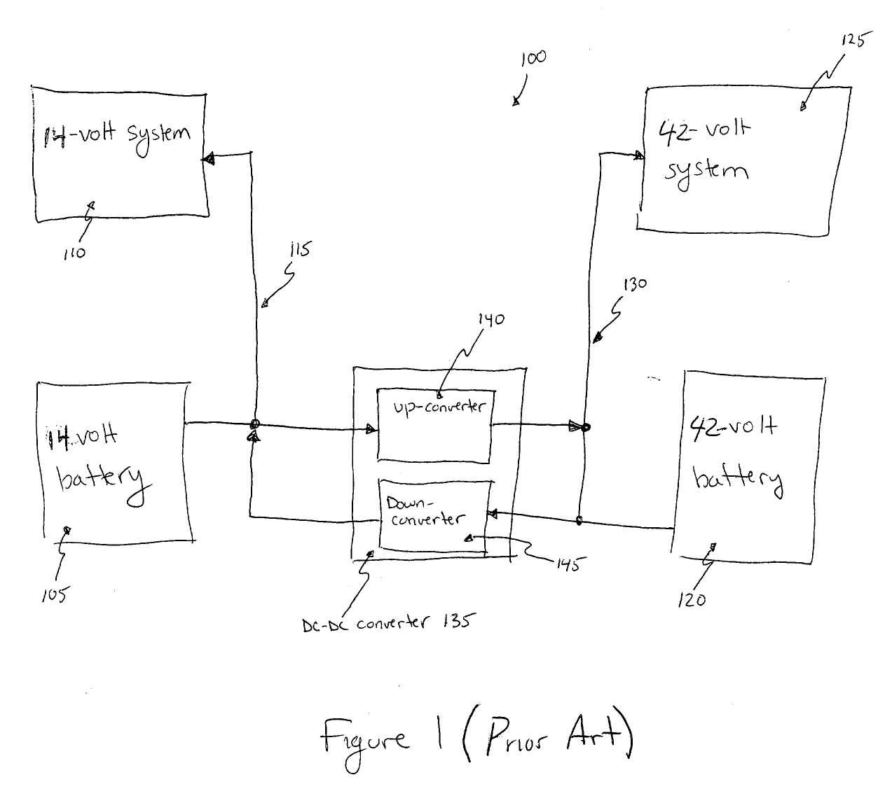

FIG. 2 is a first exemplary electrical system according to the present invention.

FIG. 3 is a second exemplary electrical system according to the present invention.

FIG. 4 is one embodiment of a bi-directional DC-DC converter.

### DETAILED DESCRIPTION

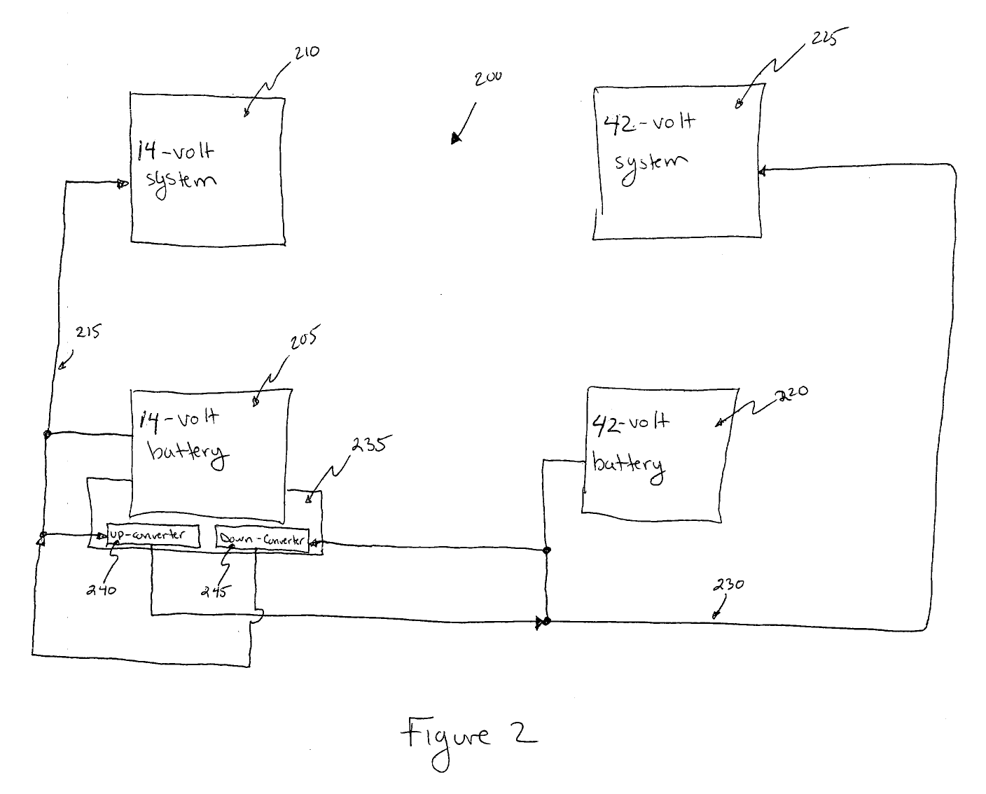

Referring now to FIG. 2, there is seen a first exemplary electrical arrangement 200 according to the present invention. The electrical arrangement 200 comprises a fourteen-volt battery 205 electrically coupled to at least one fourteen-volt electrical system 210 via a fourteen-volt bus 215, a fortytwo-volt battery 220 electrically coupled to at least one fortytwo-volt electrical system 225 via a fortytwo-volt bus 230, and a bi-directional DC-DC converter 235 electrically coupled to both fourteen-volt bus 215 and fortytwo-volt bus 230.

The electrical arrangement 200 requires comparatively less space than conventional DC-DC converters, and further comprises a DC-DC converter 235 that is designed to be a low-profile and mechanically and proximally coupled to a surface (e.g., bottom, side, or top surface) of one of batteries 205, 220 (e.g., FIG. 2 shows converter 235 coupled to the bottom surface of battery 205).

To achieve a planar construction of DC-DC converter 235, the converter 235 may be constructed from a plurality planar converter stages, each provided with low impedance planar converter coils, for example, planar coils made of punched solid copper, with the interconnection being effected by Direct Bonded Copper (DBC) or thick film substrate using a bare MOSFET device. To increase magnetic field conduction, each stage may also be provided with a flat ferrite core. Furthermore, ceramic capacitors may be provided for EMI filtering, thereby increasing reliable performance of the planar converter 235.

It should be appreciated that, although FIG. 2 illustrates a hybrid fourteen-volt/fortytwo-volt arrangement 200, electrical arrangement 200 may include batteries and electrical systems of different voltage potentials, such as 5-volt, 12-volt, 36-volt, etc. Furthermore, it will be appreciated that DC-DC converter 235 may be mechanically and proximally coupled to fortytwo-volt battery 220, rather than fourteen-volt battery 105. For example, DC-DC converter 235 may be mechanically and proximally coupled to the bottom surface of fortytwo-volt battery 220.

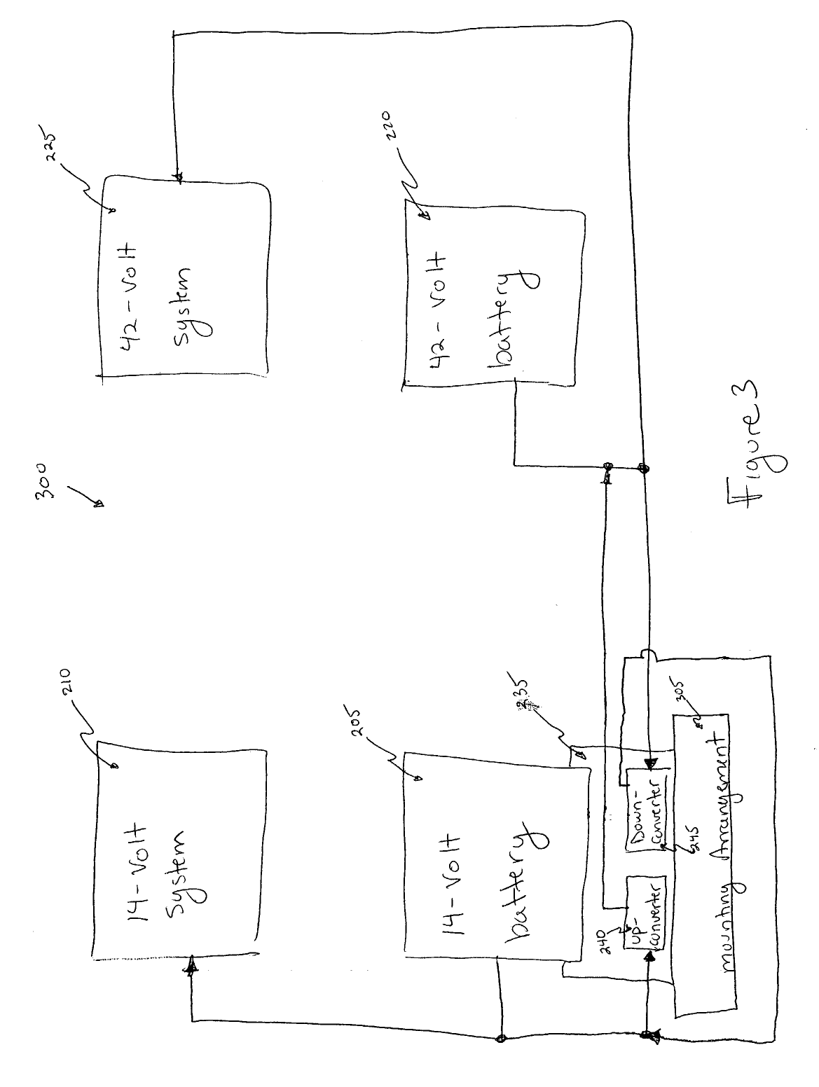

Referring now to FIG. 3, there is seen another exemplary electrical arrangement 300. Electrical arrangement 300 is similar to electrical arrangement 200, except that DC-DC converter 235 is mechanically and heat-conductively coupled to a mounting arrangement 305 operable to dissipate heat to the environment. In automobile applications, for example, mounting arrangement 305 may comprise, for example, a portion of the vehicle chassis. In this manner, the mounting arrangement 300 may dissipate excess heat produced by DC-DC converter 235 to the environment. To facilitate an efficient heat-conductive bond between DC-DC converter 235 and mounting arrangement 305, a heat conductive paste, for example, a silver thermal compound (not shown), may be applied to the surface(s) of DC-DC converter 235 and/or mounting arrangement 305 before mechanically and heat-conductively coupling DC-DC converter 235 to mounting arrangement 300.

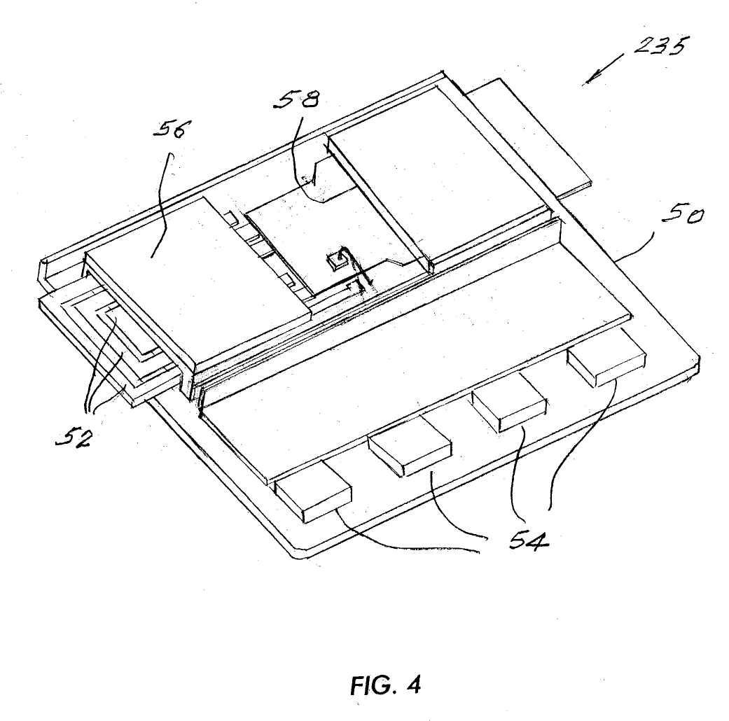

Referring now to FIG. 4, there is seen a DC-DC converter 235 comprising a plurality of electronic components that provide bi-directional DC-DC conversion in a low profile package. For example, flat ferrite 56 is placed adjacent to windings 52. Additional electronic components 54, 58 are electrically connected in a circuit with the windings 52, providing electronic filtering and input-output for the DC-DC converter 235, including control input, while maintaining the low profile of the package. By bi-directional, it is meant that the conversion direction can be changed by using a control input. In one example, baseplate 50 is thermally conductive, such as a highly thermally conductive metal, metal alloy or composite baseplate.

The foregoing descriptions and drawings are merely exemplary and should not be considered limiting; the present invention should be limited only by the claims.

What is claimed is:

1. An electrical arrangement to provide power to a plurality of electrical systems, the electrical arrangement comprising:
a plurality of voltage buses;
a plurality of voltage sources configured to supply respective electrical voltage potentials, the voltage sources being respectively assigned to the voltage buses, the voltage sources supplying the respective electrical voltage potentials to the respective voltage buses;
at least one electrical system assigned to and electrically coupled to each of the voltage buses to receive electrical power; and
a DC-DC converter arrangement electrically coupled to the voltage buses, the DC-DC converter being configured to convert at least one of the respective voltage potentials to another one of the respective voltage potentials, the DC-DC converter being mechanically and proximally coupled to at least one of the voltage sources.

2. The electrical arrangement according to claim 1, wherein the DC-DC converter includes a control input operable to select which of the respective voltage potentials to convert.

3. The electrical arrangement according to claim 1, wherein the plurality of voltage buses includes only two voltage buses.

4. The electrical arrangement according to claim 3, wherein the two voltage buses include a fourteen-volt bus and a forty-two volt bus.

5. The electrical arrangement according to claim 1, wherein the DC-DC converter includes a control input operable to select which of the two voltage buses to convert.

6. The electrical arrangement according to claim 1, wherein the DC-DC converter is mechanically and proximally coupled to one of a bottom surface, a side surface, and a top surface of at least one of the voltage sources.

7. The electrical arrangement according to claim 1, wherein the DC-DC converter is a planar DC-DC converter.

8. The electrical arrangement according to claim 7, wherein the planar DC-DC converter includes a plurality of planar converter stages, each of the stages being provided with low impedance planar converter coils.

9. The electrical arrangement according to claim 8, wherein the low impedance planar converter coils include planar coils made of punched solid copper.

10. The electrical arrangement according to claim 8, wherein the plurality of planar converter stages are interconnected by one of a Direct Bonded Copper material and a thick film substrate.

11. The electrical arrangement according to claim 8, wherein each of the planar converter stages is provided with a flat ferrite core.

12. The electrical arrangement according to claim 8, wherein each of the planar converter stages is provided with at least one EMI filtering ceramic capacitor to increase reliable performance of the planar DC-DC converter.

13. The electrical arrangement according to claim 1, further comprising a mounting arrangement mechanically and heat-conductively coupled to the DC-DC converter to dissipate heat to an environment.

14. The electrical arrangement according to claim 13, wherein the mounting arrangement forms at least part of an automobile chassis.

15. The electrical arrangement according to claim 13, further comprising a heat conductive silver thermal compound arranged between the DC-DC converter and the mounting arrangement to better conduct the heat to the environment.

16. A hybrid automobile, comprising:
an automobile including a plurality of automobile electrical systems, the automobile electrical systems including a first set of electrical systems and a second set of electrical systems; and
an electrical arrangement to provide power to the automobile electrical systems, the electrical arrangement including:
first and second voltage buses, the first and second electrical systems being assigned to and electrically coupled to the first and second voltage buses, respectively, to receive electrical power,
first and second voltage sources assigned to the first and second voltage buses, respectively, the voltage sources being configured to supply respective electrical voltage potentials to the first and second voltage buses, respectively, and
a DC-DC converter arrangement electrically coupled to the first and second voltage buses, the DC-DC converter being configured to convert at least one of the respective voltage potentials to the other one of the respective voltage potentials, the DC-DC converter being mechanically and proximally coupled to at least one of the voltage sources.

17. The hybrid automobile according to claim 16, wherein the automobile includes a chassis, the hybrid automobile further comprising a mounting arrangement mechanically and heat-conductively coupled to the DC-DC converter to dissipate heat to an environment.

18. The hybrid automobile according to claim 17, wherein the automobile further includes a chassis, the mounting arrangement forming at least a portion of the chassis.

19. The hybrid automobile according to claim 17, wherein the DC-DC converter is a planar DC-DC converter.

20. The hybrid automobile according to claim 19, wherein the planar DC-DC converter includes a plurality of planar converter stages, each of the stages being provided with low impedance planar converter coils.
